(19) United States
(12) Patent Application Publication
(10) Pub. No.: US 2004/0245689 A1
(43) Pub. Date: Dec. 9, 2004

(54) Method for operating a hydraulic bearing and corresponding bearing

(76) Inventors: Stefan Loheide, Wallenhorst (DE); Burkhard Meyer, Dinklage (DE); Hubert Siemer, Dinklage (DE)

Correspondence Address: McGlew & Tuttle, Scarborough Station, Scarborough, NY, 10510-0827, US

(21) Appl. No.: 10/484,830

(22) PCT Filed: Mar. 21, 2003
(86) PCT No.: PCT/DE03/00943

(30) Foreign Application Priority Data
Mar. 28, 2002 (DE) 102 14 325.0

(51) Int. Cl. F16F 5/00

(52) U.S. Cl. 267/140.11; 267/140.14

(57) ABSTRACT

A process is provided for operating a hydraulic bearing and a bearing is provided designed for carrying out the process. The process makes it possible to directly affect the complex transmission characteristic of a hydraulic bearing and to provide a bearing suitable for this. A defined force is directly introduced into the bearing in a contactless manner into the oscillatory system, namely, in the area of the overflow channel or the overflow channels. The direction vector of this force is superimposed in parallel as well as in phase or antiphase to the direction vector of the damping agent moving through the overflow channel or overflow channels. In the bearing at least one overflow channel accommodates a mass element, which is displaceable in the overflow channel by a force generated by means of a magnetic field and can thus be affected concerning its force which comes to act in addition to the restoring force of the buckling springs of the oscillatory system.

### FIELD OF TH INVENTION

The present invention pertains to a process for operating a hydraulic bearing and to a bearing designed for carrying out the process.

### BACKGROUND OF THE INVENTION

Bearings, especially rubber bearings, are widely used in the automotive industry. The automobile manufacturers seek to steadily increase the comfort of vehicles. Besides the expansion and the improvement of the operating functions, damping measures are above all of great significance in this connection, the goal of these measures being to keep noise and vibrations caused by the vibration sources of the vehicle and by unevennesses of the road surface extensively away from the passenger compartment. Rubber bearings and rubber bushings are usually used in such applications. Their spring and damping properties are utilized, e.g., for mounting the engine or the subframe. Depending on the special use of the particular bearing, different requirements are imposed on the spring and damping properties of the bearing. Adaptation to these different requirements is achieved, in general, by varying the geometry of the bearing and/or the hardness as well as the elasticity of the rubber. However, the possibilities offered by this are limited. High vibration amplitudes of certain frequencies, as they occur, e.g., during the idle of the engine or because of periodic actions of forces on the chassis, can be damped with rubber bearings of the conventional design only insufficiently, or they require undesired large bearing weights. Hydraulic bearings which make possible the effective damping of high vibration amplitudes while having a low own weight have therefore been used increasingly frequently. The hydraulic bearings comprise an elastomeric carrier body of a conventional design known from rubber bearings and an oscillatory system. The oscillatory system is formed by chambers integrated in the carrier body for receiving a fluid damping agent, the walls of the said chambers and one or more overflow channels that connect the chambers to one another. A mixture of preferably glycol and water is usually used as the damping agent. When vibrations are introduced into such bearings, the volume of the chambers changes because of the inward spring deflection. This change in volume is absorbed by the flexible chamber walls. However, the chamber walls offer a resistance to the change in shape, and this resistance leads to a change in pressure in the chambers. One indicator of the change in pressure due to volume displacement is called buckling spring rate. As a consequence of the overflow of the damping agent from one chamber into the other, a pressure equalization takes place through the channel connecting the chambers to each other. The pressure equalization takes place directly between the chambers in the case of low vibration frequencies, so that only the elastomeric carrier body will contribute to the spring excursion and damping of the bearing. However, as the frequency of vibration increases, the damping is brought about increasingly by the oscillatory system, namely, by the mass of the liquid vibrating to and fro in the channel. However, the liquid moving to and fro is no longer able to follow the vibrations introduced due to its inertia above a certain frequency (natural frequency). The damping characteristic of the bearing breaks down, and a stiffness, which is added to the stiffness of the carrier body, develops above the pressure applied by the liquid to the chamber walls. The natural frequency of the particular bearings now depends on the geometry of the bearing, especially the geometry of the channel, and the amount of liquid. Depending on the nature and the construction of the components and modules to be connected, it is necessary to tune the bearings differently with respect to their natural frequencies. Even slight changes in construction, which are often necessary in the development of vehicles, have a direct effect on the tuning to be performed for the bearings. It is therefore desirable to design the bearings such that their damping characteristic can be adapted to the changed conditions in a simple manner. One known possibility for this is, e.g., to change the properties of the carrier body by positioning an additional spring or rubber arrangement in parallel to or in series with the hydraulic bearing proper. Moreover, bearings with variable channel length or variable channel cross section have also become known for this purpose. Corresponding to the previous solutions, electric, hydraulic or pneumatic drives are used for this purpose. Actuators in the bearing are actuated by means of these and the bearing geometry or the properties of a carrier body are thus changed. However, this requires moving parts within the bearing and ducts for moving the corresponding parts. As a consequence, there is an increase in the requirements imposed on the sealing of the areas of the bearing through which the damping agent flows.

A hydraulically damping bearing, whose stiffness properties can be changed specifically, has been known from DE 199 59 391 A1. The bearing has two short uncoupling channels, besides an overflow channel. The oscillatory system of the bearing is uncoupled by means of these uncoupling channels at low amplitudes. Pressure differences occurring in the bearing are compensated here via the uncoupling channels rather than via the overflow channel. The oscillatory system is consequently short-circuited when vibrations of a low amplitude occur. According to the solution disclosed in the document, an oscillating body each is integrated in the uncoupling channels. These oscillating bodies brake the flow of liquid through the uncoupling channels. Depending on the intensity of this braking action, the amplitude beginning from which the overflow channel contributes to the pressure equalization can be affected, i.e., the degree of uncoupling can be set. According to the document, a change in the braking action is achieved by means of a pin, which laterally presses the oscillating body with a variable force. In the embodiment of the bearing disclosed in the document, the variable force is transmitted to the pin in a contactless manner and is introduced perpendicularly or at right angles to the longitudinal direction of the uncoupling channels. It is generated, e.g., by a magnet. The bearing being described consequently acts, if extrapolated to electrical engineering, in a manner comparable to a threshold value switch. The threshold value (vibration amplitude) up to which the oscillatory body is uncoupled from the overall system is set here depending on the force acting perpendicularly on the oscillating body. However, it is not possible to specifically affect the damping caused by the oscillatory system, which begins after this threshold value has been exceeded, with this arrangement.

### SUMMARY OF THE INVENTION

The object of the present invention is to provide a process which makes it possible to directly affect the complex transmission characteristic of a hydraulic bearing. Furthermore, the object is to create a bearing suitable for carrying out the process.

The process according to the present invention pertains to the operation of a hydraulic bearing, which is formed by an elastomeric carrier body and an oscillatory system. The oscillatory system comprises at least chambers integrated in the carrier body for receiving a fluid damping agent, the walls of the said chambers, which walls act as buckling springs, and one or more overflow channels connecting the chambers to each other. The complex transmission characteristic or the damping characteristic of the bearing is affected by means of the process in a predetermined manner by a defined force being introduced in a contactless manner directly into the oscillatory system, namely, in the area of the overflow channel or the overflow channels. According to the present invention, the direction vector of this force is superimposed to the direction vector of the damping agent moving through the overflow channel or the overflow channels during the stressing of the bearing in parallel, in phase or in antiphase. “Complex” is defined here such that both the amount of the stiffness and the phase between the excitation and the transmitted action of the force are affected by the present invention, the phase-shifted component corresponding to the damping characteristic of the bearing.

In the sense of the present invention, the force introduced into the oscillatory system is a static force for setting the complex transmission characteristic or the damping characteristic of the bearing, corresponding to the intended use of the bearing, and a dynamically variable force, whose amount and/or direction vector changes corresponding to the particular stress on the bearing during its use.

Corresponding to a preferred variant of the process according to the present invention, the force introduced into the oscillatory system is caused by a magnetic field, in which case the oscillatory system comprises at least one mass element, which can be displaced by the force of the magnetic field and on which this force acts. In a practical embodiment, the acting force is generated by an electromagnet. Depending on the particular application, a process regimen is also provided in which the direction of the electromagnetic field generated by the electromagnet is variable during the operation of the bearing due to the application of an alternating voltage, so that the complex transmission characteristic of the bearing can be affected as a result in response to the particular stress to which it is subject.

The process according to the present invention comprises the coupling of static and/or dynamic forces with the mass of the liquid column present in the channel in a contactless manner. This is equivalent to affecting the oscillatory system, which is characterized by the mass of the channel (liquid column) and the spring rate of the buckling springs formed by the walls of the chambers, in a direct, but contactless manner. As a result, the complex transmission characteristic of the bearing can be set highly accurately and flexibly in the sense of a pretuning before its installation or in respect to a variable reaction to occurring loads. This goes markedly beyond the mere uncoupling of the oscillatory system from the overall system as needed. It is possible to counteract the movement of the liquid column (antiphase superimposition) or to support the movement of the liquid column (in-phase superimposition) due to the direct action on the oscillatory system and the parallel superimposition of the direction vector describing the movement of the oscillating liquid to the vector of the acting force. Thus, the damping action of the bearing can be set completely freely within certain limits due to the simultaneous variation of the amount of the acting force. The hydraulic bearing suitable for carrying out the process is designed as an engine mount or chassis mount or as a bush bearing as desired. In the manner known per se, it comprises an elastomeric carrier body and an oscillatory system, which is formed by chambers integrated in the carrier body for receiving a fluid damping agent, the walls of the said chambers, which walls act as buckling springs, as well as one or more overflow channels connecting the chambers with each other. According to the present invention, at least one overflow channel accommodates a mass element, which can be displaced by a force generated by means of a magnetic field in the overflow channel and can consequently be affected in terms of its force that becomes effective in addition to the restoring force of the buckling springs of the oscillatory system. The term “addition” relates here to a vector-oriented view of the forces superimposed to each other and it may thus, of course, also mean a substraction in terms of the amount.

Corresponding to a practical embodiment of the bearing according to the present invention, the mass element is a piston-like solid. There are various possibilities of generating the force resulting from a magnetic field. One possibility is to design the mass element as a soft magnetic solid, on which a magnetic field acts, which is generated by a permanent magnet arranged outside and in the vicinity of the overflow channel. According to another embodiment, the mass element is a permanent magnet, on which the magnetic field of another permanent magnet or of a current-carrying coil acts. Finally, the mass element itself may accommodate a short-circuited coil or be designed as such a coil, in which case a voltage is induced in this coil by means of a variable external magnetic field. Eddy currents, which build up a magnetic field directed opposite the particular cause around the coil and thus around the mass element, are generated in the coil by the voltage. The variable external magnetic field may be generated, for example, by a permanent magnet, which is inserted into the carrier body and changes its position in relation to the coil during a stress on the bearing.

The present invention will be explained once again in greater detail below on the basis of an exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawing and descriptive matter in which a preferred embodiment of the invention is illustrated.

### BRIEF DESCRIPTION OF THE DRAWING

FIG. 1 is a schematic view showing a hydraulic bearing according to the invention.

### DESCRIPTION OF THE PREFERRED EMBODIMENT

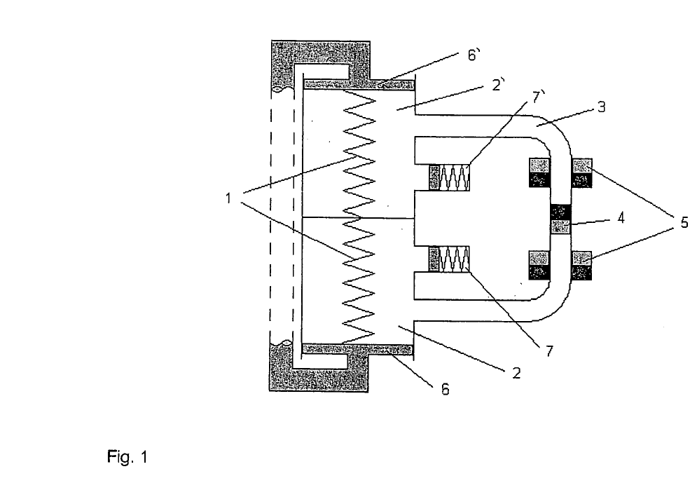

Referring to the drawing in particular, FIG. 1 shows, comparably to an equivalent circuit, the schematic view of a bearing, where it is of no significance for the explanation of the principle of action of the present invention whether the bearing is, e.g., an engine mount with damping agent channels arranged axially one on top of another or a bush bearing with chambers located at least radially opposite each other. When viewed in this way, the bearing is a kind of parallel circuit between the elastomeric carrier body 1— illustrated by symbolized bearing springs—and the oscillatory system 2, 2′, 3, 7, 7′, which comprises at least chambers 2, 2′ for receiving a fluid damping agent, the walls of the chambers 2, 2′, which said walls act as buckling springs 7, 7′, and one or more—one in the example—overflow channels 3 connecting the chambers 2, 2′. Forces acting on the bearing due to the use are introduced into the bearing via the active surfaces 6, 6′. If the vibrations are low-frequency vibrations, these lead to a change in volume in the chambers 2, 2′, and these changes in volume lead to a change in the pressure acting on the fluid damping agent contained in the chambers. However, there is an immediate pressure equalization between the chambers 2, 2′ in the case of such low vibration frequencies, because the damping agent flows directly via the overflow channel from the chamber 2 or 2′, which reduces its volume, into the respective other chamber 2′ or 2. As a result, the oscillatory system 2, 2′, 3, 7, 7′ formed from the chambers 2, 2′ with the buckling springs 7, 7′, the fluid damping agent (not recognizable) and the channel 3 does not basically contribute to the damping when such low-frequency vibrations occur. The spring excursion or damping of the bearing is rather affected under such operating conditions only by the elastomeric carrier body 1 of the bearing.

However, the contribution of the oscillatory system to the damping becomes increasingly significant as the frequency of the vibrations acting on the bearing in the operating state increases. This contribution results from the spring rate of the buckling springs 7, 7′, which is determined by the deformability of the chamber walls, the internal friction of the damping agent during its movement through the channel, and the dynamic pressure losses, which develop during the oscillation of the liquid to and fro. The complex transmission characteristic, the damping characteristic and consequently also the natural frequency are determined very substantially by the so-called channel mass. It is precisely here that the present invention begins. As is apparent from FIG. 1, a mass element 4 is introduced into the overflow channel 3 in the bearing according to the present invention. It is a piston-like permanent magnet in the example being shown. The piston can be moved in the channel 3 in a contactless manner because of the magnetic attracting or repelling forces by means of an additional magnet 5 arranged in its vicinity outside the overflow channel (permanent magnet or current-carrying coil or electromagnet). This corresponds to the direct introduction of a force acting on the oscillatory system into the channel 3. The direction vector of this force is superimposed in parallel to the direction vector of the liquid moving in the channel 3 or the force corresponding to this movement. Depending on whether this transmission takes place in phase or antiphase at a certain point in time being considered, the action of the buckling spring 7 and 7′ is reduced (in-phase transmission) or increased (antiphase transmission). If the introduction of the force alternates in terms of direction and amount due to magnetic fields which are variable in time and are generated by an electromagnet to which an alternating voltage is applied, the complex transmission characteristic of the bearing is variable not only in respect to a pretuning, but also dynamically. The working point of the bearing can thus be set within certain limits statically and dynamically without changing the channel geometry, i.e., also in response to the particular stress.

One special advantage of the present invention is that the dynamic stiffness remains fully unaffected by the force introduced into the oscillatory system far above the natural frequency of the hydraulic bearing or the hydraulic bushing. Moreover, another advantage can be seen in the fact that when excitation fails to occur, i.e., e.g., when the electromagnet whose magnetic field acts on the piston fails to operate, a defined working state will nevertheless become established, which arises from the mass of the channel corresponding to the usual design of the bearing plus the mass of the unaffected mass element. Furthermore, there are many different possibilities of affecting the oscillatory system in the case of the use of coils due to the fact that the time course of the coil current can be selected nearly as desired. No guides or joints are needed because of the absence of complicated moving parts. As a result, the design of the bearing remains comparatively simple, which leads to favorable production costs. Likewise, additional seals are unnecessary, because no special sealing measures become necessary. This also has a favorable effect on the production costs and increases the reliability of the bearing.

While a specific embodiment of the invention has been shown and described in detail to illustrate the application of the principles of the invention, it will be understood that the invention may be embodied otherwise without departing from such principles.

1-10. (Canceled)

11. A process for operating a hydraulic bearing, the process comprising:
providing an elastomeric carrier body;
forming an oscillatory system with chambers incorporated in the carrier body for receiving a fluid damping agent, the walls of the chambers acting as buckling springs; and
providing one or more overflow channels connecting the chambers to each other;
introducing a defined force in a contactless manner directly into the oscillatory system in the area of the overflow channel or the overflow channels, the direction vector of the force being superimposed in parallel as well in phase or antiphase to the direction vector of the damping agent moving through the overflow channel or the overflow channels during stress on the bearing to affect the complex transmission characteristic and/or the damping characteristic of the bearing in a predetermined manner.

12. A process in accordance with claim 11, wherein the force introduced into the oscillatory system is a static force for setting the damping characteristic of the bearing corresponding to its intended use or a dynamically variable force, whose amount and/or direction vector change correspondingly with the particular stress on the bearing during its use.

13. A process in accordance with claim 11, wherein the force introduced into the oscillatory system is generated by a magnetic field, the oscillatory system comprising at least one mass element displaceable by the force of the magnetic field.

14. A process in accordance with claim 13, wherein the magnetic field is built up by means of an electromagnet.

15. A process in accordance with claim 14, wherein the direction of the electromagnetic field generated by the electromagnet and consequently of the force caused by it is variable during the operation of the bearing by applying an alternating current to the electromagnet.

16. A hydraulic bearing as an engine mount or chassis mount or as a bush bearing, the bearing comprising:
an elastomeric carrier body;
an oscillatory system formed by chambers integrated in the elastomeric carrier body and filled with a fluid damping agent, walls of the chambers acting as buckling springs and one or more overflow channels connecting the chambers to each other, a mass element accommodated in said at least one overflow channel and a magnet, said mass element being displaceable in said at least one overflow channel by a magnetic field of said magnet and can affected in terms of a force that comes to act in addition to the restoring force of the buckling springs of the oscillatory system.

17. A hydraulic bearing in accordance with claim 16, wherein the mass element is a solid having a piston action in said at least one overflow channel.

18. A hydraulic bearing in accordance with claim 16, wherein the mass element is a soft magnetic solid, on which acts a magnetic field generated by a permanent magnet or said electromagnet arranged outside the overflow channel in its vicinity.

19. A hydraulic bearing in accordance with claim 16, wherein the mass element is a permanent magnet, whose magnetic field interacts with a permanent magnet or a coil arranged outside the overflow channel in its vicinity.

20. A hydraulic bearing in accordance with claim 16, wherein the mass element is designed as a short-circuited coil or accommodates such a coil, in which a voltage is induced by means of a variable external magnetic field, so that a magnetic field directed opposite the particular cause is generated by the eddy currents resulting herefrom in the coil.

21. A hydraulic bearing in accordance with claim 17, wherein the mass element is a soft magnetic solid, on which acts a magnetic field generated by a permanent magnet or said electromagnet arranged outside the overflow channel in its vicinity.

22. A hydraulic bearing in accordance with claim 17, wherein the mass element is a permanent magnet, whose magnetic field interacts with a permanent magnet or a coil arranged outside the overflow channel in its vicinity.

23. A hydraulic bearing in accordance with claim 17, wherein the mass element is designed as a short-circuited coil or accommodates such a coil, in which a voltage is induced by means of a variable external magnetic field, so that a magnetic field directed opposite the particular cause is generated by the eddy currents resulting herefrom in the coil.

24. A hydraulic bearing comprising:
an elastomeric carrier body;
chambers integrated in the elastomeric carrier body and filled with a fluid damping agent;
buckling springs formed by walls of the chambers;
an overflow channel connecting the chambers to each other;
a mass element accommodated in said overflow channel; and
a magnetic means for generating a magnetic field for displacing said overflow channel to create a fluid force acting in addition to the restoring force of the buckling springs of the oscillatory system.

25. A hydraulic bearing in accordance with claim 24, wherein said mass element is a solid forming a piston in said overflow channel.

26. A hydraulic bearing in accordance with claim 25, wherein said mass element is a soft magnetic solid, and said magnetic means includes a permanent magnet or an electromagnet arranged outside said overflow channel in a vicinity of said overflow channel.

27. A hydraulic bearing in accordance with claim 25, wherein said mass element is a permanent magnet having a magnetic field interacting with said magnetic means, said magnetic means including one or more of a permanent magnet and a coil arranged outside of said overflow channel in a vicinity of said overflow channel.

28. A hydraulic bearing in accordance with claim 25, wherein said mass element is a short-circuited coil or a structure accommodating a short-circuited coil, whereby a voltage is induced by a variable external magnetic field of said magnetic means with a resulting magnetic field in said coil generated by the eddy currents in the coil.
